(19) United States
(12) Patent Application Publication
(10) Pub. No.: US 2021/0158175 A1
(43) Pub. Date: May 27, 2021

(54) ASSET ADDITION SCHEDULING FOR A KNOWLEDGE BASE

(71) Applicant: International Business Machines Corporation, Armonk, NY (US)

(72) Inventors: Craig M. Trim, Ventura, CA (US); Michael Bender, Rye Brook, NY (US); Aaron K. Baughman, Cary, NC (US); Martin G. Keen, Cary, NC (US)

(73) Assignee: International Business Machines Corporation, Armonk, NY (US)

(21) Appl. No.: 16/692,907

(22) Filed: Nov. 22, 2019

(51) Int. Cl. G06N 5/02; G06F 16/242

(52) U.S. Cl. CPC G06N 5/022; G06F 16/243

(57) ABSTRACT

For a first query classification, a query time series is constructed, the query time series comprising a set of natural language queries classified into the first query classification received per unit of time. For a first asset classification, a topic time series is constructed, the topic time series comprising a set of knowledge assets classified into the first asset classification added to a set of knowledge assets per unit of time. From the query time series and the topic time series, a decision tree is generated. By navigating the decision tree, a schedule is generated, the schedule forecasting a time at which a future knowledge asset should be added to the set of knowledge assets in time to answer a future natural language query relative to the knowledge asset.

### TECHNICAL FIELD

The present invention relates generally to a method, system, and computer program product for maintenance of a knowledge base with which to answer user queries. More particularly, the present invention relates to a method, system, and computer program product for asset addition scheduling for a knowledge base.

### BACKGROUND

A knowledge base is a collection of information about a particular subject. A question-and-answer (Q&A) system is a software application that attempts to answer user queries. Knowledge bases are often used in Q&A systems as the information such systems use to answer a query. A query is natural language text seeking information from a knowledge base. A query need not be grammatically correct and need not be in the form of a grammatical question. For example, “Tell me about Product A,” “Product A ship date,” and “When does Product A ship to customers'?” are all queries.

A knowledge asset is an item within a knowledge base, used to answer a query. A knowledge asset can be added to a knowledge base in the form of a portion of data (for example, a weather observation for a particular location), a natural language text document (for example, a user manual for a product), a database of information (e.g., data used to generate, upon request, a current weather forecast for a particular location), a portion of streaming information (e.g., data of weather observations for a particular location as each is observed), a set of knowledge structures (e.g., rules generated by a knowledge engineer for how a human performs a task), or in another form.

### SUMMARY

The illustrative embodiments provide a method, system, and computer program product. An embodiment includes a method that constructs, for a first query classification, a query time series, the query time series comprising a set of natural language queries classified into the first query classification received per unit of time. An embodiment constructs, for a first asset classification, a topic time series, the topic time series comprising a set of knowledge assets classified into the first asset classification added to a set of knowledge assets per unit of time. An embodiment generates, from the query time series and the topic time series, a decision tree. An embodiment generates, by navigating the decision tree, a schedule, the schedule forecasting a time at which a future knowledge asset should be added to the set of knowledge assets in time to answer a future natural language query relative to the knowledge asset.

An embodiment includes a computer usable program product. The computer usable program product includes one or more computer-readable storage devices, and program instructions stored on at least one of the one or more storage devices.

An embodiment includes a computer system. The computer system includes one or more processors, one or more computer-readable memories, and one or more computer-readable storage devices, and program instructions stored on at least one of the one or more storage devices for execution by at least one of the one or more processors via at least one of the one or more memories.

### BRIEF DESCRIPTION OF THE DRAWINGS

Certain novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts a block diagram of a network of data processing systems in which illustrative embodiments may be implemented;

FIG. 2 depicts a block diagram of a data processing system in which illustrative embodiments may be implemented;

FIG. 3 depicts a block diagram of an example configuration for asset addition scheduling for a knowledge base in accordance with an illustrative embodiment;

FIG. 4 depicts an example of asset addition scheduling for a knowledge base in accordance with an illustrative embodiment;

FIG. 5 depicts another example of asset addition scheduling for a knowledge base in accordance with an illustrative embodiment;

FIG. 6 depicts another example of asset addition scheduling for a knowledge base in accordance with an illustrative embodiment;

FIG. 7 depicts a flowchart of an example process for asset addition scheduling for a knowledge base in accordance with an illustrative embodiment; and

FIG. 8 depicts a flowchart of an example process for asset addition scheduling for a knowledge base in accordance with an illustrative embodiment.

### DETAILED DESCRIPTION

The illustrative embodiments recognize that determining when, and with what granularity, a knowledge asset should be added to a knowledge base is difficult. To anticipate user queries, an asset should be added before queries regarding the asset are expected to occur. However, more details regarding a subject are often developed over time. If an asset is added too soon, before sufficient detail has been developed, information needed to answer a query could be incomplete. In addition, there is often a cost associated with adding a knowledge asset—for example, in human time necessary to develop the information or in money paid for data. If an asset is added too soon, any associated acquisition cost could be incurred earlier than necessary. In addition, a knowledge base that includes too much information, on too many subjects, is often subject to false positive results, as the Q&A system responds to a query with information that appears to correlate positively with the query but does not actually answer the query.

As well, if information in the knowledge base is insufficiently detailed (i.e., insufficiently granular) to answer user queries, users will not receive the information they require. On the other hand, if information in the knowledge base is too detailed (i.e., too granular), any cost associated with obtaining the extra information will have been spent unnecessarily. For example, consider a knowledge base used to answer user queries on weather observations and forecasts. While observations at a scale of a few hundred meters and every-five-minute forecasts are appropriate when answering queries about a currently-occurring, localized phenomenon such as a tornado, such granular data is unnecessary when answering queries about whether next winter will have more snowfall than average. In addition, knowledge gaps—subjects for which the knowledge base has insufficient or overly granular data—can be difficult to identify and fill.

Consequently, the illustrative embodiments recognize that there is an unmet need to optimize the scheduling of knowledge asset additions, and the content of those additions, relative to queries expected regarding those additions.

The illustrative embodiments recognize that the presently available tools or solutions do not address these needs or provide adequate solutions for these needs. The illustrative embodiments used to describe the invention generally address and solve the above-described problems and other problems related to asset addition scheduling for a knowledge base.

An embodiment can be implemented as a software application. The application implementing an embodiment can be configured as a modification of an existing knowledge base or Q&A system, as a separate application that operates in conjunction with an existing knowledge base or Q&A system, a standalone application, or some combination thereof.

Particularly, some illustrative embodiments provide a method of generating a decision tree from time series data of query and knowledge asset types, and using the decision tree to generate a schedule forecasting a time at which a future knowledge asset should be added in time to answer a future natural language query about the asset. A decision tree is a flowchart-like structure in which each internal node represents a decision for a variable (e.g. whether a value of the variable is true or false), each branch represents a path taken due to the decision, and each leaf, or terminal, node represents a class determined by the outcomes of each decision in the path.

An embodiment classifies natural language queries of a knowledge base into one or more query classifications. Some non-limiting examples of query classifications are a topic of a query (e.g., today's local weather forecast), a role of the querier (e.g. an end user, a sales representative, or a customer service representative), a query type, and a depth of knowledge required to respond to a query. To classify queries, an embodiment uses any presently-available Natural Language Processing (NLP) or Natural Language Understanding (NLU) technique to receive natural language input, convert the input from another form (e.g., audio) into text if necessary, and analyze the content of the input. One embodiment classifies queries as each query is received from a user. Another embodiment classifies a set of queries received and responded to by a Q&A system at an earlier time. Another embodiment classifies a set of queries received and responded to by a different system, or by one or more human experts. An expert system, search engine, technical support portal, user forum hosted on a website, and a section of a social network are non-limiting examples of sources of natural language query data. Another embodiment receives already-classified query data from another source.

An embodiment constructs a time series for a query classification. A time series is a series of data points indexed, listed, or graphed in time order. In particular, an embodiment constructs a time series for a query classification in which each data point is a number of queries of the classification received by a Q&A system within a particular period of time. Time periods are typically equally long (e.g., one day, week, or month), but equal time periods are not required.

An embodiment classifies knowledge assets of a knowledge base into one or more knowledge asset classifications. Some non-limiting examples of knowledge asset classifications are a topic of an asset (e.g., a database of weather forecast data for a particular region), a role of a querier to which an asset is directed (e.g. information directed to an end user or to a technical support representative), a type of an asset, and a depth of knowledge contained within an asset. To classify a knowledge asset in natural language form, an embodiment uses any presently-available Natural Language Processing (NLP) or Natural Language Understanding (NLU) technique to receive natural language input, convert the input from another form (e.g., audio) into text if necessary, and analyze the content of the input. To classify a knowledge asset that is not in natural language form, but is instead in the form of structured data, an embodiment uses any technique suitable to the type of data. One embodiment classifies knowledge assets as each is added to a knowledge base. Another embodiment classifies knowledge assets previously added to a knowledge base. Another embodiment receives already-classified knowledge asset data from another source.

An embodiment constructs a time series for a knowledge asset classification, in which each data point is a number of knowledge assets of the classification added to a knowledge base within a particular period of time. Time periods are typically equally long (e.g., one day, week, or month), but equal time periods are not required.

An embodiment models at least one query classification time series and at least one knowledge asset classification time series. In particular, an embodiment fits time series data, from one or a set of time series, to a Seasonal Autoregressive Integrated Moving Average (sARIMA) forecasting model. A sARIMA model forecasts the next step in a time series as a linear function of the differenced observations, errors, differenced seasonal observations, and seasonal errors at prior times. In particular, a sARIMA model is denoted in parameter form as ARIMA(p, d, q) (P, D, Q) m, where non-seasonal element p denotes trend autoregression order, d denotes trend difference order, and q denotes trend moving average order, while seasonal element P denotes seasonal autoregressive order, D denotes seasonal difference order, Q denotes seasonal moving average order, and m denotes the number of time steps for a single seasonal period. For example, if one seasonal period is one year and the time series data is computed for every month, m would be 12. The elements P, D, Q, m, p, d, and q are also called variables. One embodiment arranges model output in a matrix, in which each of the first n columns represent variables contributing to a seasonal variation (for example, a weekly, monthly, or yearly variation) in a forecasted time series, the rightmost column represents the seasonal variation, and the rows hold forecasted data for a particular variable.

An embodiment uses the modeled time series data to generate a forecasted decision tree with bifurcated segmentation. Each internal node in the decision tree represents a decision for a variable from the set of variables identified using the model, each branch represents a path taken due to the decision, and each leaf, or terminal, node represents a class determined by the outcomes of each decision in the path. One embodiment sorts variables from most to least important in contributing to an outcome, and optionally does not include variables below a threshold ability to contribute to an outcome. A variable can also be repeated within a tree, using different decisions at different nodes. For example, “temperature” might be a variable determining a path at one node, where the possible paths are either >90 degrees F. or <=90 degrees F. The same variable might also re-appear in a subsequent node with another decision: <100 degrees F. or >=100 degrees F.

Thus, the generated decision tree represents queries a user is likely to ask at a future time and knowledge assets used to answer those queries. The decision tree need not include all variables identified using the modeled time series data. Instead, for efficiency a tree is configurable to include only the variables that contribute most to a forecast, without the need to evaluate additional variables that have below a threshold effect on the forecast.

An embodiment navigates the decision tree by starting at the root node and selecting a path according to a decision for a variable at each node until the embodiment reaches a leaf node. For example, a decision tree including the example temperature variable can be used to answer an example query, “How will hot weather impact customer shipments'?” An embodiment uses the example decision tree to answer the question by treating “hot weather” as any decision involving the decision path >90 degrees F.

An embodiment is also configurable to ask a clarifying question in response to a query, if the embodiment determines that above a threshold amount of information will be returned in response to a query or the result provided is below a threshold confidence level, because the query is too general or ambiguous.

Because the generated decision tree represents forecasted queries and knowledge assets, by navigating the decision tree an embodiment generates a schedule forecasting a time at which a future knowledge asset should be added to the set of knowledge assets in time to answer a future natural language query relative to the knowledge asset.

An embodiment analyzes a set of knowledge assets to determine whether there are gaps in the set that should be filled with additional information. In particular, an embodiment selects a query for which a response is already present in the set of knowledge assets. An embodiment generates one or more over-specified and one or more under-specified queries from the selected query. An over-specified query calls for more detail than the original query or refers to a subset of the information sought in the original query, while an under-specified query calls for less detail than the original query or refers to a superset of the information sought in the original query. For example, consider a query about cats. A corresponding over-specified query might seek information about kittens, while a corresponding under-specified query might seek information about animals.

An embodiment applies the set of over-specified and under-specified queries to a knowledge base and compares the responses to a response to the original query. An over-specified query resulting in a more detailed response than the original means that the knowledge base includes sufficient detail with which to answer queries. Inversely, an under-specified query resulting in a less detailed response than the original means that the knowledge base includes sufficient generality with which to answer queries. Thus, a response having above a threshold similarity to the response to the original query indicates a lack of the required details, identifying a knowledge gap in the knowledge base that should be filled with one or more additional knowledge assets. An embodiment uses the decision tree to generate a revised schedule forecasting a time at which an additional knowledge asset should be added to the set of knowledge assets to fill the identified knowledge gap.

The manner of asset addition scheduling for a knowledge base described herein is unavailable in the presently available methods in the technological field of endeavor pertaining to knowledge base maintenance and use. A method of an embodiment described herein, when implemented to execute on a device or data processing system, comprises substantial advancement of the functionality of that device or data processing system in generating a decision tree from time series data of query and knowledge asset types, and using the decision tree to generate a schedule forecasting a time at which a future knowledge asset should be added in time to answer a future natural language query about the asset.

The illustrative embodiments are described with respect to certain types of queries, responses, knowledge assets, knowledge bases, classifications, time series, forecasts, thresholds, rankings, adjustments, sensors, measurements, devices, data processing systems, environments, components, and applications only as examples. Any specific manifestations of these and other similar artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

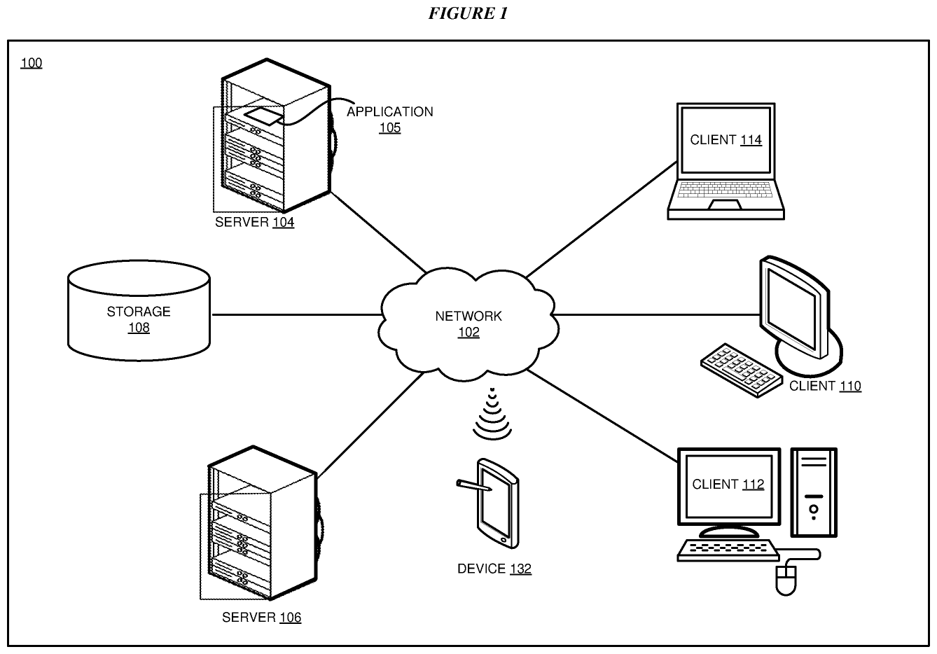

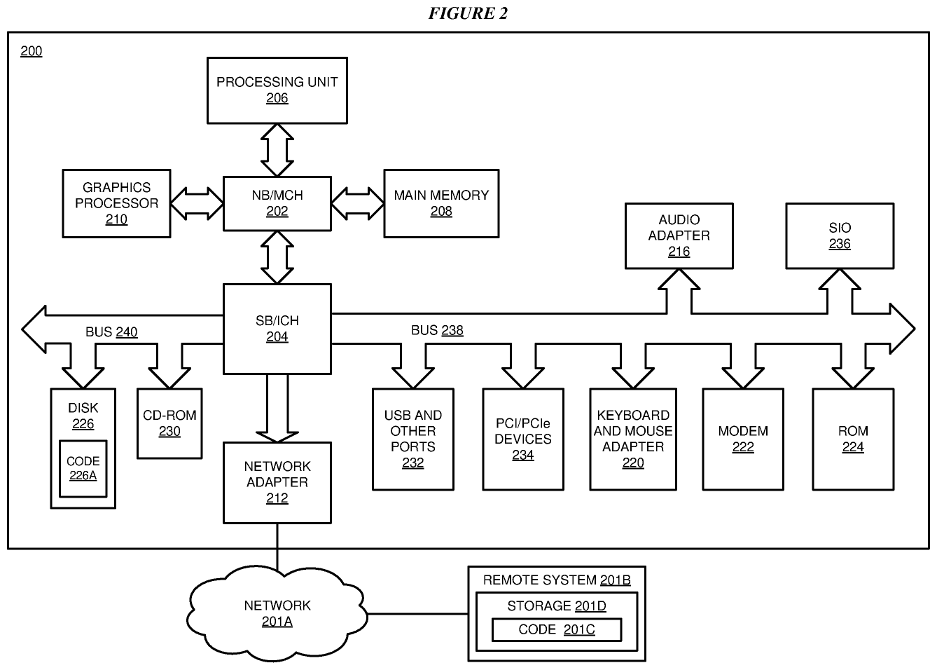

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables.

Clients or servers are only example roles of certain data processing systems connected to network 102 and are not intended to exclude other configurations or roles for these data processing systems. Server 104 and server 106 couple to network 102 along with storage unit 108. Software applications may execute on any computer in data processing environment 100. Clients 110, 112, and 114 are also coupled to network 102. A data processing system, such as server 104 or 106, or client 110, 112, or 114 may contain data and may have software applications or software tools executing thereon.

Only as an example, and without implying any limitation to such architecture, FIG. 1 depicts certain components that are usable in an example implementation of an embodiment. For example, servers 104 and 106, and clients 110, 112, 114, are depicted as servers and clients only as example and not to imply a limitation to a client-server architecture. As another example, an embodiment can be distributed across several data processing systems and a data network as shown, whereas another embodiment can be implemented on a single data processing system within the scope of the illustrative embodiments. Data processing systems 104, 106, 110, 112, and 114 also represent example nodes in a cluster, partitions, and other configurations suitable for implementing an embodiment.

Device 132 is an example of a device described herein. For example, device 132 can take the form of a smartphone, a tablet computer, a laptop computer, client 110 in a stationary or a portable form, a wearable computing device, or any other suitable device. Any software application described as executing in another data processing system in FIG. 1 can be configured to execute in device 132 in a similar manner. Any data or information stored or produced in another data processing system in FIG. 1 can be configured to be stored or produced in device 132 in a similar manner.

Application 105 implements an embodiment described herein. Application 105 executes in any of servers 104 and 106, clients 110, 112, and 114, and device 132.

Servers 104 and 106, storage unit 108, and clients 110, 112, and 114, and device 132 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications. Data processing environment 100 may also take the form of a cloud, and employ a cloud computing model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service.

With reference to FIG. 2, this figure depicts a block diagram of a data processing system in which illustrative embodiments may be implemented. Data processing system 200 is an example of a computer, such as servers 104 and 106, or clients 110, 112, and 114 in FIG. 1, or another type of device in which computer usable program code or instructions implementing the processes may be located for the illustrative embodiments.

Data processing system 200 is also representative of a data processing system or a configuration therein, such as data processing system 132 in FIG. 1 in which computer usable program code or instructions implementing the processes of the illustrative embodiments may be located. Data processing system 200 is described as a computer only as an example, without being limited thereto. Implementations in the form of other devices, such as device 132 in FIG. 1, may modify data processing system 200, such as by adding a touch interface, and even eliminate certain depicted components from data processing system 200 without departing from the general description of the operations and functions of data processing system 200 described herein.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to NB/MCH 202 through an accelerated graphics port (AGP) in certain implementations.

In the depicted example, local area network (LAN) adapter 212 is coupled to South Bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and I/O controller hub 204 through bus 238. Hard disk drive (HDD) or solid-state drive (SSD) 226 and CD-ROM 230 are coupled to South Bridge and I/O controller hub 204 through bus 240. PCI/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE), serial advanced technology attachment (SATA) interface, or variants such as external-SATA (eSATA) and micro-SATA (mSATA). A super I/O (SIO) device 236 may be coupled to South Bridge and I/O controller hub (SB/ICH) 204 through bus 238.

Memories, such as main memory 208, ROM 224, or flash memory (not shown), are some examples of computer usable storage devices. Hard disk drive or solid state drive 226, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system for any type of computing platform, including but not limited to server systems, personal computers, and mobile devices. An object oriented or other type of programming system may operate in conjunction with the operating system and provide calls to the operating system from programs or applications executing on data processing system 200.

Instructions for the operating system, the object-oriented programming system, and applications or programs, such as application 105 in FIG. 1, are located on storage devices, such as in the form of code 226A on hard disk drive 226, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory 224, or in one or more peripheral devices.

Furthermore, in one case, code 226A may be downloaded over network 201A from remote system 201B, where similar code 201C is stored on a storage device 201D. in another case, code 226A may be downloaded over network 201A to remote system 201B, where downloaded code 201C is stored on a storage device 201D.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a mobile or wearable device.

Where a computer or data processing system is described as a virtual machine, a virtual device, or a virtual component, the virtual machine, virtual device, or the virtual component operates in the manner of data processing system 200 using virtualized manifestation of some or all components depicted in data processing system 200. For example, in a virtual machine, virtual device, or virtual component, processing unit 206 is manifested as a virtualized instance of all or some number of hardware processing units 206 available in a host data processing system, main memory 208 is manifested as a virtualized instance of all or some portion of main memory 208 that may be available in the host data processing system, and disk 226 is manifested as a virtualized instance of all or some portion of disk 226 that may be available in the host data processing system. The host data processing system in such cases is represented by data processing system 200.

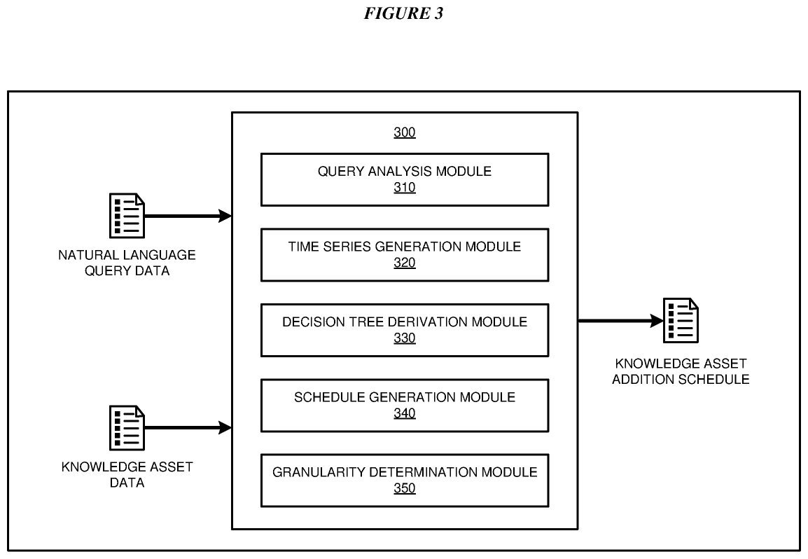

With reference to FIG. 3, this figure depicts a block diagram of an example configuration for asset addition scheduling for a knowledge base in accordance with an illustrative embodiment. Application 300 is an example of application 105 in FIG. 1 and executes in any of servers 104 and 106, clients 110, 112, and 114, and device 132 in FIG. 1.

Query analysis module 310 classifies natural language queries of a knowledge base into one or more query classifications. To classify queries, module 310 uses any presently-available Natural Language Processing (NLP) or Natural Language Understanding (NLU) technique to receive natural language input, convert the input from another form (e.g., audio) into text if necessary, and analyze the content of the input. One implementation of module 310 classifies queries as each query is received from a user. Another implementation of module 310 classifies a set of queries received and responded to by a Q&A system at an earlier time. Another implementation of module 310 classifies a set of queries received and responded to by a different system, or by one or more human experts. An expert system, search engine, technical support portal, user forum hosted on a website, and a section of a social network are non-limiting examples of sources of natural language query data.

Time series generation module 320 constructs a time series for a query classification in which each data point is a number of queries of the classification received by a Q&A system within a particular period of time. Module 320 also constructs a time series for a knowledge asset classification, in which each data point is a number of knowledge assets of the classification added to a knowledge base within a particular period of time. Time periods in each time series are typically equally long (e.g., one day, week, or month), but equal time periods are not required.

Decision tree derivation module 330 models at least one query classification time series and at least one knowledge asset classification time series, by fitting time series data to a Seasonal Autoregressive Integrated Moving Average (sARIMA) forecasting model. In one implementation, module 330 arranges model output in a matrix, in which each of the first n columns represent variables contributing to a seasonal variation (for example, a weekly, monthly, or yearly variation) in a forecasted time series, the rightmost column represents the seasonal variation, and the rows hold forecasted data for a particular variable. Module 330 uses the modeled time series data to generate a forecasted decision tree with bifurcated segmentation. Each internal node in the decision tree represents a decision for a variable from the set of variables identified using the model, each branch represents a path taken due to the decision, and each leaf, or terminal, node represents a class determined by the outcomes of each decision in the path. Thus, the generated decision tree represents queries a user is likely to request at future time and the knowledge assets used to answer those queries. The decision tree need not include all variables identified using the modeled time series data. Instead, for efficiency a tree is configurable to include only the variables that contribute most to a forecast, without the need to evaluate additional variables that have below a threshold effect on the forecast.

Schedule generation module 340 navigates the decision tree by starting at the root node and selecting a path according to a decision for a variable at each node until the embodiment reaches a leaf node. Because the generated decision tree represents forecasted queries and knowledge assets, by navigating the decision tree module 340 generates a schedule forecasting a time at which a future knowledge asset should be added to the set of knowledge assets in time to answer a future natural language query relative to the knowledge asset.

Granularity determination module 350 analyzes a set of knowledge assets to determine whether there are gaps in the set that should be filled with additional information. In particular, module 350 selects a query for which a response is already present in the set of knowledge assets and generates one or more over-specified and one or more under-specified queries from the selected query. Module 350 applies the set of over-specified and under-specified queries to a knowledge base and compares the responses to a response to the original query. An over-specified query resulting in a more detailed response than the original means that the knowledge base includes sufficient detail with which to answer queries. Inversely, an under-specified query resulting in a less detailed response than the original means that the knowledge base includes sufficient generality with which to answer queries. Thus, a response having above a threshold similarity to the response to the original query indicates a lack of the required details, identifying a knowledge gap in the knowledge base that should be filled with one or more additional knowledge assets. Module 340 uses the decision tree to generate a revised schedule forecasting a time at which an additional knowledge asset should be added to the set of knowledge assets to fill the identified knowledge gap.

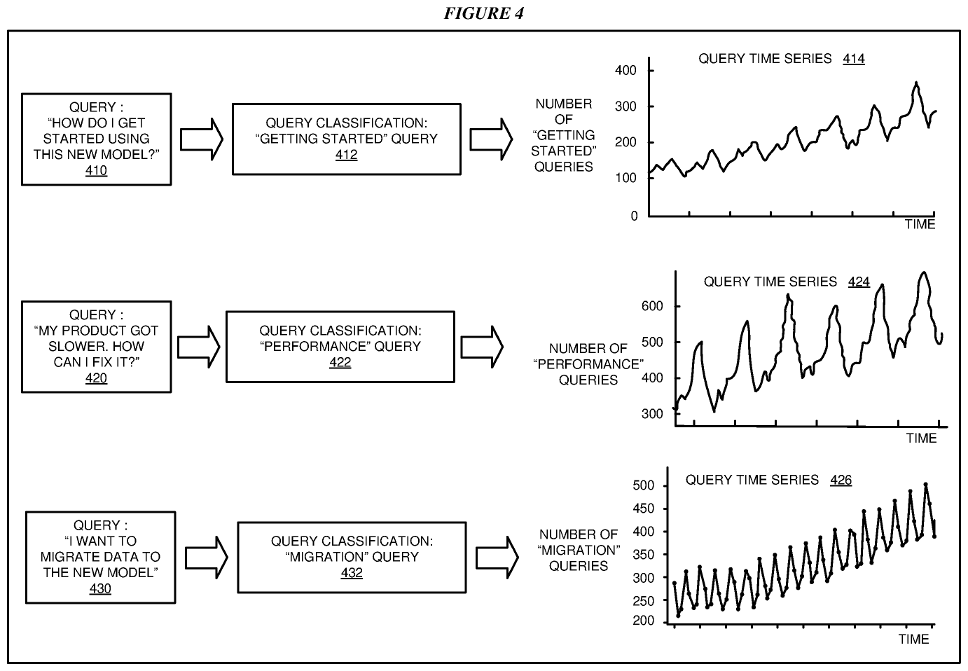

With reference to FIG. 4, this figure depicts an example of asset addition scheduling for a knowledge base in accordance with an illustrative embodiment. The example can be executed using application 300 in FIG. 3.

FIG. 4 depicts the processing of queries received at a Q&A system configured to respond to product queries. Product queries are a non-limiting example of a subject typically subject to seasonal variations, often the result of periodic new product releases, updates to existing products, popular seasons for gift-buying, and the like. Application 300 receives query 410, and classifies it into query classification 412—a “getting started” query. Application 300 constructs query time series 414, which plots the number of “getting started” queries received within a particular period of time. Application 300 receives query 420, and classifies it into query classification 422—a “performance” query. Application 300 constructs query time series 444, which plots the number of “performance” queries received within a particular period of time. Application 300 receives query 430, and classifies it into query classification 432—a “migration” query. Application 300 constructs query time series 434, which plots the number of “migration” queries received within a particular period of time.

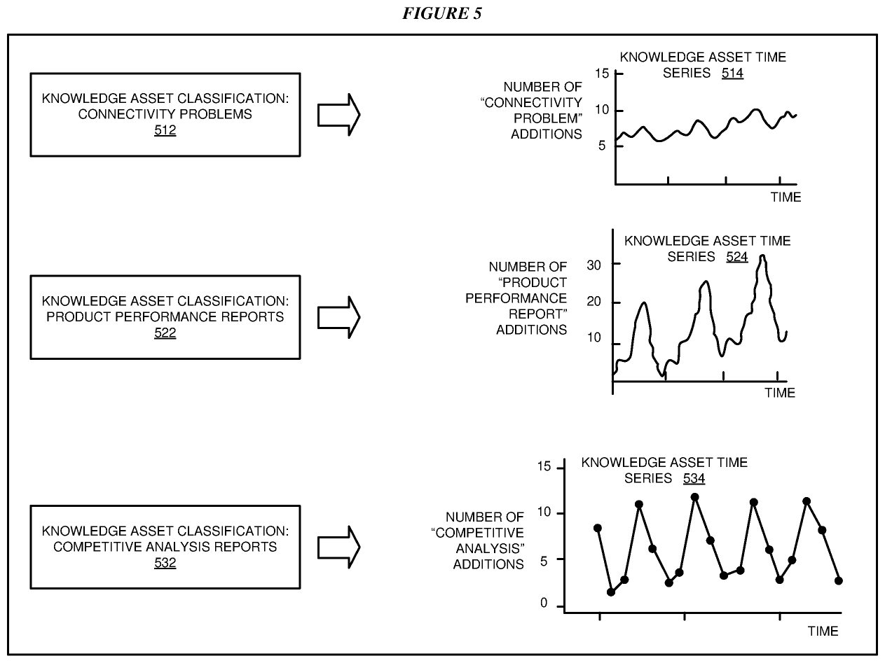

With reference to FIG. 5, this figure depicts another example of asset addition scheduling for a knowledge base in accordance with an illustrative embodiment. The example can be executed using application 300 in FIG. 3.

FIG. 5 depicts time series generation for knowledge asset classifications within a knowledge base configured to hold information used to respond to product queries. Because product queries are often subject to seasonal variations, a knowledge base configured to respond to such queries often requires periodic additions, to accommodate new products and updates to existing products. In particular, knowledge asset classification 512 includes knowledge assets on the subject of connectivity problems. Application 300 constructs knowledge asset time series 514, which plots the number of knowledge assets on the subject of connectivity problems added to the knowledge base within a particular period of time. Knowledge asset classification 514 includes knowledge assets reporting on product performance. Application 300 constructs knowledge asset time series 524, which plots the number of knowledge assets reporting on product performance added to the knowledge base within a particular period of time. Knowledge asset classification 534 includes knowledge assets reporting on competitive analysis. Application 300 constructs knowledge asset time series 534, which plots the number of knowledge assets reporting on competitive analysis added to the knowledge base within a particular period of time.

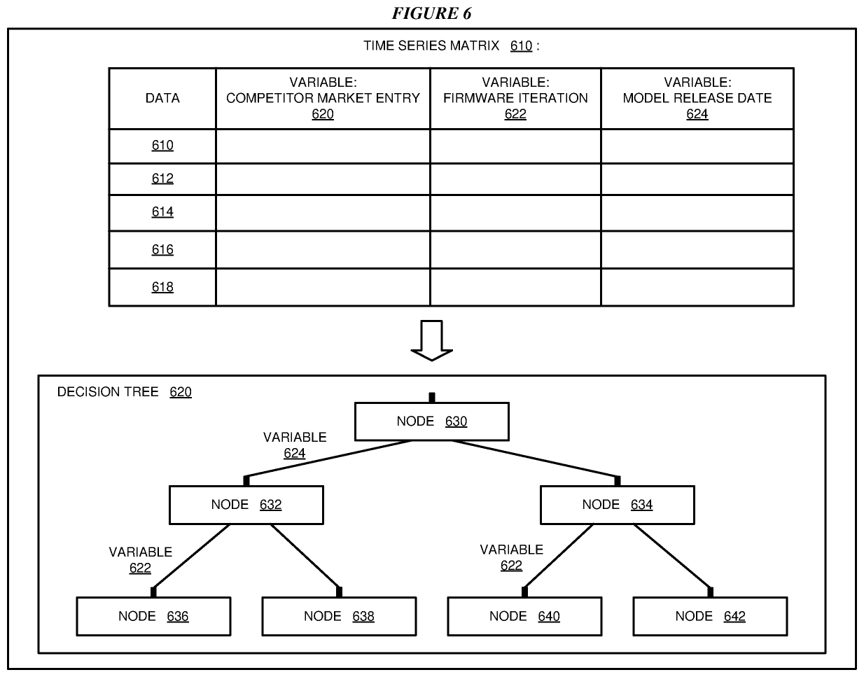

With reference to FIG. 6, this figure depicts another example of asset addition scheduling for a knowledge base in accordance with an illustrative embodiment. The example can be executed using application 300 in FIG. 3.

As depicted, application 300 has modeled one or more query classification time series and knowledge asset classification time series, producing time series matrix 610. In matrix 610, columns 620 and 622 represent variables contributing to a seasonal variation (for example, a weekly, monthly, or yearly variation) in a forecasted time series, column 624 represents the seasonal variation, and rows 610, 612, 614, 616, and 618 hold forecasted data for a particular variable. The forecasted data is not depicted.

Application 300 uses the modeled time series data to generate decision tree 620, a forecasted decision tree with bifurcated segmentation. Each internal node in decision tree 620 represents a decision for a variable from the set of variables identified using the model, each branch represents a path taken due to the decision, and each leaf, or terminal, node represents a class determined by the outcomes of each decision in the path. Thus, application navigates decision tree 620 by starting at root node 630 and selecting a path according to a decision for variable 624. Depending on the decision, application 300 proceeds to either node 632 or node 634. At either node, application 300 selects a path according to a decision for variable 622, proceeding to one of nodes 636, 638, 640, and 642. Nodes 636, 638, 640, and 642 are leaf nodes, so application 300 does not navigate further.

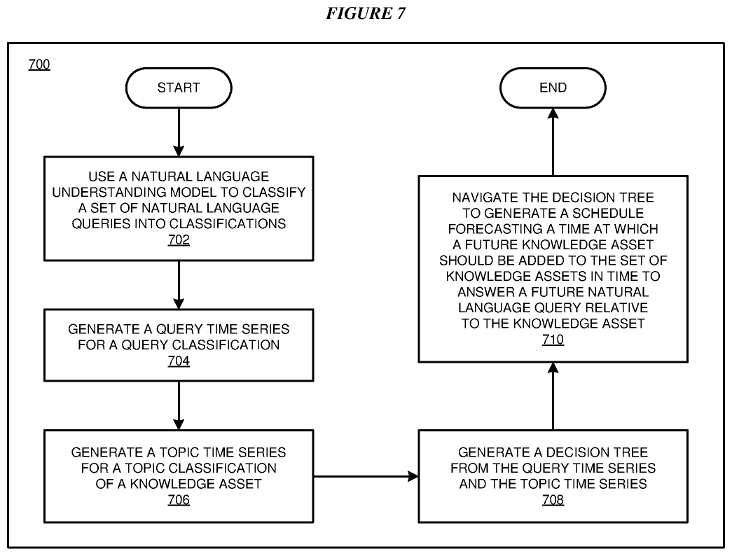

With reference to FIG. 7, this figure depicts a flowchart of an example process for asset addition scheduling for a knowledge base in accordance with an illustrative embodiment. Process 700 can be implemented in application 300 in FIG. 3.

In block 702, the application uses a natural language understanding model to classify a set of natural language queries into classifications. In block 704, the application generates a query time series for a query classification. In block 706, the application generates a topic time series for a topic classification of a knowledge asset. In block 708, the application generates a decision tree from the query time series and the topic time series. In block 710, the application navigates the decision tree to generate a schedule forecasting a time at which a future knowledge asset should be added to the set of knowledge assets in time to answer a future natural language query relative to the knowledge asset. Then the application ends.

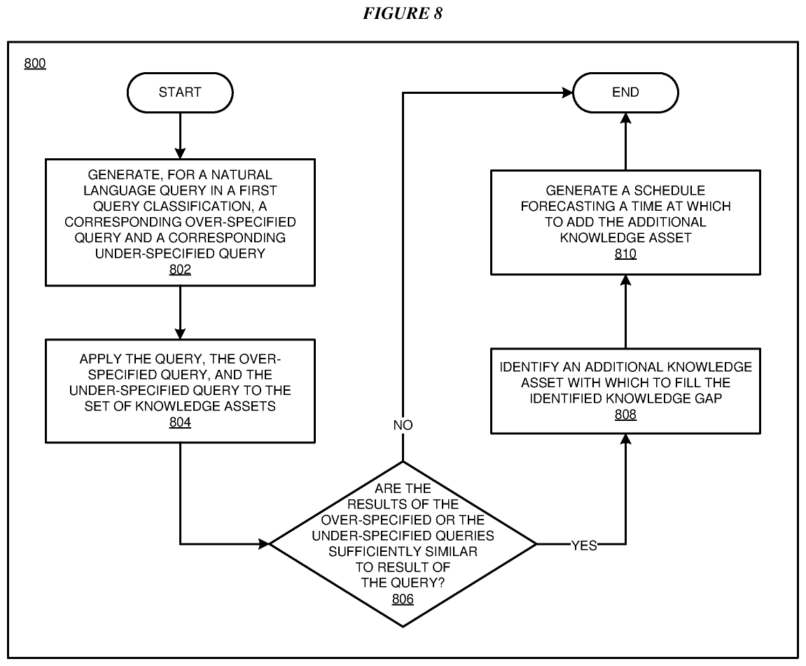

With reference to FIG. 8, this figure depicts a flowchart of an example process for asset addition scheduling for a knowledge base in accordance with an illustrative embodiment. Process 800 can be implemented in application 300 in FIG. 3.

In block 802, the application generates, for a natural language query in a first query classification, a corresponding over-specified query and a corresponding under-specified query. In block 804, the application applies the query, the over-specified query, and the under-specified query to the set of knowledge assets. In block 806, the application checks whether the results of the over-specified or under-specified queries are sufficiently similar to the results of the query. If not (“NO” path of block 806), no knowledge gap has been identified and the application ends. Otherwise, (“YES” path of block 806), in block 808 the application identifies an additional knowledge asset with which to fill the identified knowledge gap. In block 810, the application generates a schedule forecasting a time at which to add the additional knowledge asset. Then the application ends.

Thus, a computer implemented method, system or apparatus, and computer program product are provided in the illustrative embodiments for asset addition scheduling for a knowledge base and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method comprising:
constructing, for a first query classification, a query time series, the query time series comprising a set of natural language queries classified into the first query classification received per unit of time;
constructing, for a first asset classification, a topic time series, the topic time series comprising a set of knowledge assets classified into the first asset classification added to a set of knowledge assets per unit of time;
generating, from the query time series and the topic time series, a decision tree; and
generating, by navigating the decision tree, a schedule, the schedule forecasting a time at which a future knowledge asset should be added to the set of knowledge assets in time to answer a future natural language query relative to the knowledge asset.

2. The computer-implemented method of claim 1, further comprising:
classifying, using a Natural Language Understanding model, a first natural language query into the first query classification.

3. The computer-implemented method of claim 1, further comprising:
classifying, using a Natural Language Understanding model, a first knowledge asset into the first asset classification.

4. The computer-implemented method of claim 1, wherein generating, from the query time series and the topic time series, the decision tree comprises:
modeling, using a Seasonal Autoregressive Integrated Moving Average forecasting model, the query time series and the topic time series;
generating, using a set of variables identified by the modeling, the decision tree.

5. The computer-implemented method of claim 1, further comprising:
generating, for a natural language query in the first query classification, an over-specified query, the over-specified query specifying a subset of information requested by the natural language query;
generating, responsive to determining that a first result of applying the natural language query to the set of knowledge assets and a second result of applying the over-specified query to the set of knowledge assets are within a threshold similarity to each other, a revised schedule, the revised schedule forecasting a time at which a knowledge asset identified using the similarity between the over-specified query and the natural language query should be added to the set of knowledge assets.

6. The computer-implemented method of claim 1, further comprising:
generating, for a natural language query in the first query classification, an under-specified query, the under-specified query specifying a superset of information requested by the natural language query;
generating, responsive to determining that a first result of applying the natural language query to the set of knowledge assets and a second result of applying the under-specified query to the set of knowledge assets are within a threshold similarity to each other, a revised schedule, the revised schedule forecasting a time at which a knowledge asset identified using the similarity between the under-specified query and the natural language query should be added to the set of knowledge assets.

7. A computer usable program product comprising one or more computer-readable storage devices, and program instructions stored on at least one of the one or more storage devices, the stored program instructions comprising:
program instructions to construct, for a first query classification, a query time series, the query time series comprising a set of natural language queries classified into the first query classification received per unit of time;
program instructions to construct, for a first asset classification, a topic time series, the topic time series comprising a set of knowledge assets classified into the first asset classification added to a set of knowledge assets per unit of time;
program instructions to generate, from the query time series and the topic time series, a decision tree; and
program instructions to generate, by navigating the decision tree, a schedule, the schedule forecasting a time at which a future knowledge asset should be added to the set of knowledge assets in time to answer a future natural language query relative to the knowledge asset.

8. The computer usable program product of claim 7, further comprising:
program instructions to classify, using a Natural Language Understanding model, a first natural language query into the first query classification.

9. The computer usable program product of claim 7, further comprising:
program instructions to classify, using a Natural Language Understanding model, a first knowledge asset into the first asset classification.

10. The computer usable program product of claim 7, wherein program instructions to generate, from the query time series and the topic time series, the decision tree comprises:
program instructions to model, using a Seasonal Autoregressive Integrated Moving Average forecasting model, the query time series and the topic time series;
program instructions to generate, using a set of variables identified by the modeling, the decision tree.

11. The computer usable program product of claim 7, further comprising:
program instructions to generate, for a natural language query in the first query classification, an over-specified query, the over-specified query specifying a subset of information requested by the natural language query;
program instructions to generate, responsive to determining that a first result of applying the natural language query to the set of knowledge assets and a second result of applying the over-specified query to the set of knowledge assets are within a threshold similarity to each other, a revised schedule, the revised schedule forecasting a time at which a knowledge asset identified using the similarity between the over-specified query and the natural language query should be added to the set of knowledge assets.

12. The computer usable program product of claim 7, further comprising:
program instructions to generate, for a natural language query in the first query classification, an under-specified query, the under-specified query specifying a superset of information requested by the natural language query;
program instructions to generate, responsive to determining that a first result of applying the natural language query to the set of knowledge assets and a second result of applying the under-specified query to the set of knowledge assets are within a threshold similarity to each other, a revised schedule, the revised schedule forecasting a time at which a knowledge asset identified using the similarity between the under-specified query and the natural language query should be added to the set of knowledge assets.

13. The computer usable program product of claim 7, wherein the stored program instructions are stored in the at least one of the one or more storage devices of a local data processing system, and wherein the stored program instructions are transferred over a network from a remote data processing system.

14. The computer usable program product of claim 7, wherein the stored program instructions are stored in the at least one of the one or more storage devices of a server data processing system, and wherein the stored program instructions are downloaded over a network to a remote data processing system for use in a computer readable storage device associated with the remote data processing system.

15. A computer system comprising one or more processors, one or more computer-readable memories, and one or more computer-readable storage devices, and program instructions stored on at least one of the one or more storage devices for execution by at least one of the one or more processors via at least one of the one or more memories, the stored program instructions comprising:
program instructions to construct, for a first query classification, a query time series, the query time series comprising a set of natural language queries classified into the first query classification received per unit of time;
program instructions to construct, for a first asset classification, a topic time series, the topic time series comprising a set of knowledge assets classified into the first asset classification added to a set of knowledge assets per unit of time;
program instructions to generate, from the query time series and the topic time series, a decision tree; and
program instructions to generate, by navigating the decision tree, a schedule, the schedule forecasting a time at which a future knowledge asset should be added to the set of knowledge assets in time to answer a future natural language query relative to the knowledge asset.

16. The computer system of claim 15, further comprising:
program instructions to classify, using a Natural Language Understanding model, a first natural language query into the first query classification.

17. The computer system of claim 15, further comprising:
program instructions to classify, using a Natural Language Understanding model, a first knowledge asset into the first asset classification.

18. The computer system of claim 15, wherein program instructions to generate, from the query time series and the topic time series, the decision tree comprises:
program instructions to model, using a Seasonal Autoregressive Integrated Moving Average forecasting model, the query time series and the topic time series;
program instructions to generate, using a set of variables identified by the modeling, the decision tree.

19. The computer system of claim 15, further comprising:
program instructions to generate, for a natural language query in the first query classification, an over-specified query, the over-specified query specifying a subset of information requested by the natural language query;
program instructions to generate, responsive to determining that a first result of applying the natural language query to the set of knowledge assets and a second result of applying the over-specified query to the set of knowledge assets are within a threshold similarity to each other, a revised schedule, the revised schedule forecasting a time at which a knowledge asset identified using the similarity between the over-specified query and the natural language query should be added to the set of knowledge assets.

20. The computer system of claim 15, further comprising:
program instructions to generate, for a natural language query in the first query classification, an under-specified query, the under-specified query specifying a superset of information requested by the natural language query;
program instructions to generate, responsive to determining that a first result of applying the natural language query to the set of knowledge assets and a second result of applying the under-specified query to the set of knowledge assets are within a threshold similarity to each other, a revised schedule, the revised schedule forecasting a time at which a knowledge asset identified using the similarity between the under-specified query and the natural language query should be added to the set of knowledge assets.
